(19) United States
(12) Patent Application Publication
(10) Pub. No.: US 2012/0248042 A1
(43) Pub. Date: Oct. 4, 2012

(54) OIL SANDS TAILINGS MANAGEMENT

(75) Inventors: David BALDREY, Calgary (CA); Francis DEPARIS, Paris (FR); Alexandre PACTAT, Billere (FR); Pedro RIBEIRO, Saint Germain-en-Laye (FR); Bill SHAW, Calgary (CA); Alexander William HYNDMAN, North Saanich (CA)

(73) Assignee: TOTAL E&P CANADA LTD., Calgary (CA)

(21) Appl. No.: 13/079,618

(22) Filed: Apr. 4, 2011

(51) Int. Cl. B01D 21/01; B01D 21/26

(52) U.S. Cl. 210/710; 210/170.01

(57) ABSTRACT

A system and method for managing fluid mature fine tailings (MFT) containment volume in a tailings pond to a minimum, fixed steady-state volume by balancing the accumulation of the MFT in the pond with consumption of the MFT from the pond by one or both of spiking the MFT into coarse sand tailings forming a coarse sand beach with trapped fines which is segregating for forming a trafficable deposit or centrifuging MFT from the tailings pond and depositing the resulting centrifuge cake on the coarse sand beach. During the life of the oil sand operation, when the volume of MFT approaches the fixed volume of the tailings pond, MFT is consumed from the pond using both sand-spiking and centrifugation as required. Production of MFT in the pond is also reduced by diverting an underflow from a secondary flotation cell in an extraction plant from the tailings pond to a thickener where the fines-rich thickened tailings from the thickener are beached for subsequent dewatering and reclamation.

### FIELD OF THE INVENTION

Embodiments of the invention relate to the management of tailings streams produced from an oil sands operation wherein bitumen is extracted using a warm water extraction process and, more particularly, to the management of fine tailings produced therefrom for minimizing fluid fine tailings containment and for optimizing formation of geotechnically stable tailings deposits.

### BACKGROUND OF THE INVENTION

Oil sands in the Athabasca region of northern Alberta constitute one of the largest hydrocarbon deposits in the world, containing about 173 billion barrels (bbls) of recoverable bitumen. Approximately 20% of this volume is surface mineable. The thickness of the hydrocarbon-bearing deposit, its continuity, the concentration or grade by percent weight bitumen it contains, and the depth from surface to the top of the mineable deposit determines whether or not an area is amenable to a surface mining operation.

Commercial recovery of mineable bitumen from Athabasca oil sands commenced in 1967 by Great Canadian Oil Sands (currently Suncor Energy), followed by Syncrude in 1977, Shell in 2002 and Canadian Natural Resources Limited (CNRL) in 2009.

Bitumen recovery from surface mined oil sand commences with the mining operation, in which large shovels sequentially excavate surface soils, overburden and the oil sand deposit. Mined oil sand material is typically hauled by trucks for further processing. Separate management of the soil and overburden is important for future reclamation activities. The oil sand itself may contain low grade bands of unprocessable interburden which is also handled separately.

Mined oil sand is trucked to an ore preparation plant (OPP) where mined oil sand is crushed and further comminuted with the addition of hot water. If warranted, chemicals to enhance bitumen recovery are added to generate a slurry which is then pipelined to an extraction plant.

The slurry is received and processed in the extraction plant, typically through a series of settling and flotation vessels where bitumen-rich froth is extracted from the bulk of the water and the solids in the slurry. The water, coarse solids and fine solids discharged from the extraction plant form large volumes of liquid tailings, typically comprising the fine solids having a diameter less than about 44 microns, and solid tailings, typically comprising the coarse solids having a diameter greater than about 44 microns. The bitumen-rich froth is further processed in a froth treatment plant to produce a final bitumen product and a smaller, froth treatment tailings stream comprising primarily fine solids and water.

The large volumes of coarse and fine solids and process water initially form a slurry which is transported to tailings impoundment facilities. Oil sand mine operators are required to safely contain all solids derived from the tailings slurry and ultimately reclaim all disturbed land to a productive state. Operators are further required to retain any remaining fluid tailings throughout the life of a mine and, at the end-of-mine life, permanently store any residual fluid.

When the tailings slurry streams are impounded during normal operations, such as with one or more tailings ponds, coarser solids separate from the water in the slurry to form beaches above and below the water surface. Some of the fine solids in the slurry are captured in the sand beaches. The remainder of the fine solids typically report to the tailings ponds, suspended throughout the water column therein. In a steady-state operation, the concentration of the suspended solids achieves a vertical distribution ranging in the tailings ponds from about 0.5 wt % at the surface to about 30 wt % at the bottom of the pond. The fines in suspension at the bottom of the pond are called mature fine tailings (MFT). Historically, MFT have been found to consolidate at inconsequential rates relative to the lifetime of a mine, resulting in large inventory accumulations during mine operation.

The accumulation of MFT as a result of conventional tailings management operations has significant consequences:

(i) tailings storage volumes must be continually increased to accommodate the increasing MFT volumes;

(ii) significant quantities of water are retained in the MFT, resulting in an equivalent demand on fresh water intake or make-up to sustain the operation; and

(iii) provision for perpetual containment of the MFT in a safe, environmentally-acceptable manner, at the end of the mining operation.

Others have attempted to reduce the accumulation of MFT inventory. In the early 1990s, a collaboration by Suncor Energy Inc. (Calgary, Alberta, Canada), Syncrude Canada Ltd. (Fort McMurray, Alberta, Canada) and the University of Alberta (Edmonton, Alberta, Canada) established the basis for a new approach to control the accumulation of MFT. The approach involves creating a blend of coarse sand tailings, fines, water and a coagulating agent, typically gypsum, in which resulting coagulated fines are purported to have sufficient strength to prevent the sand from separating from the mixture. The mixture is called composite or consolidated tailings (CT) or non-segregating tailings (NST). The weight of the sand dispersed within the CT was thought to be sufficient to accelerate the dewatering of the fines in the CT. It has been purported that a competent surface amenable to reclamation can be attained using CT in less than a decade. Successful implementation of CT has not been straightforward. Significant development work has been done primarily by Suncor and Syncrude.

For operations having sizeable inventories of “legacy” MFT in tailings ponds, CT operations have not resulted in a reduction of MFT inventory, as new MFT continues to be produced at rates greater than that which can be used in CT production. Notwithstanding the apparent advance achieved with the discovery and implementation of CT, tailings storage volumes at the operating plants have continued to exceed approved containment volumes.

As a consequence, the Energy Resources Conservation Board (ERCB) of Alberta, Canada, issued Directive 074, “Tailings Performance Criteria and Requirements for Oil Sands Mining Schemes” in 2009. The directive establishes stringent criteria for the reduction of fluid tailings and the formation of trafficable deposits, and stipulates a comprehensive protocol for reporting the performance of fine tailings deposits. In summary, Directive 074 requires that 50% of the fines in the processed oil sand ore feed be captured immediately in designated disposal areas (DDAs). Further, the fines deposited in the DDAs must achieve a minimum undrained shear strength of 5 kilopascals (kPa) in the materials deposited in the previous year and be ready for reclamation within 5 years after active deposition has ceased by ensuring that a trafficable surface layer of the deposit has a minimum undrained shear strength of 10 kPa.

There is great interest in the industry to find ways to manage oil sand tailings streams to avoid accumulation of MFT, particularly in greenfield operations, to minimize the containment volume of fluid tailings and to produce geotechnically stable deposits which can be successfully reclaimed.

### BRIEF DESCRIPTION OF THE DRAWINGS

FIG. 1 is a schematic representing a system and method for management of oil sand tailings including an arrangement of a tailings pond for fluid tailings containment and dedicated disposal areas (DDAs) for coarse and thickened tailings disposal according to an embodiment of the invention, when there is sufficient MFT in the tailings pond to support spiking of the coarse tailings to a desired fines-to-fines-plus-water ratio (FOFW);

FIG. 2 is a schematic according to FIG. 1 when there is insufficient MFT in the tailings pond to spike coarse sand tailings to the desired FOFW, at least a portion of fines for spiking the coarse tailings coming from a fines-rich thickener feed stream;

FIG. 3 is a schematic according to FIG. 1 further comprising centrifugation of MFT from the tailings pond to form a centrifuge cake when there is a greater volume of MFT than can be managed using sand-spiking alone;

FIG. 4 is a graphic illustrating a volume of contained liquid tailings over a life of an operation where the location of the tailings pond may be changed from external to in-pit; and

FIG. 5 is a cross-sectional schematic illustrating a thickened tailings beach and tailings pond over time including sand capping for reclamation according to an embodiment of the invention.

### SUMMARY OF THE INVENTION

A unique tailings management system and method variably utilizes three fines treatment processes to balance the production of mature fine tailings (MFT) with consumption of the produced MFT to maintain a substantially steady-state volume of MFT. Further, the management system and method minimize the production of MFT so that a containment volume of a tailings pond is substantially a fixed volume. The fixed volume of a tailings pond storage is relatively small and may be as much as 5 times smaller than a conventional tailings pond.

The three fines treatment processes utilized in the system are:

a main, in-plant fines thickener for thickening fines-rich streams during production combined with beaching of the thickened tailings for disposal thereof,

enhanced fines capture in coarse sand tailings which are beached by spiking the coarse sand tailings with MFT from the tailings ponds; and

a centrifuge plant for centrifuging MFT to produce a fines cake product for solids disposal.

Diverting fines-rich streams away from the tailings pond and toward the in-plant thickener reduces the production of MFT in the tailings pond.

The volume of fines and MFT directed to the three processes can be varied as fines content in the oil sand operation varies, thus increases in the amount of fines produced by an oil sands operation can be readily managed without having to increase the volume of the tailings pond.

The fines content of the spiked coarse sand tailings stream is maintained at a fines/(fines+water) ratio (FOFW) of from about 0.1 to about 0.14, for forming a trafficable deposit at the coarse sand beach. An optimum FOFW is about 0.12. Thus, MFT are consumed from the tailings pond. As MFT volumes in the tailings pond reach or exceed that which can be spiked into the coarse sand tailings while maintaining the FOFW in the range of from about 0.1 to about 0.14, residual MFT are consumed by the centrifuge plant. A solid centrifuge cake produced by the centrifuge plant is disposed of at a dedicated storage area, typically within the coarse sand beach.

In a broad aspect of the invention, a method for managing fine tailings in a continuously operating oil sands operation producing, as by-products, at least fine tailings and coarse sand tailings therefrom, the method comprising: directing a portion of the fine tailings to one or more thickeners for producing thickened tailings therefrom, the thickened tailings being substantially non-segregating; directing a portion of the fine tailings to a substantially fixed volume tailings pond, the substantially fixed volume being sufficient for containing the portion of fine tailings therein and for forming at least mature fine tailings (MFT) therefrom; and consuming the MFT from the substantially fixed volume tailings pond for maintaining a substantially steady-state volume of MFT therein and the substantially fixed volume of the tailings pond, wherein the consuming of the MFT is by one or more of spiking the coarse sand tailings with the MFT for forming spiked coarse sand tailings having an optimum fines-over-fines-plus ratio (FOFW) from about 0.10 to about 0.14 for forming segregating tailings; and centrifuging the MFT for forming a centrifuge cake for disposal.

When the volume of MFT in the substantially fixed volume tailings pond is insufficient to spike the coarse sand tailings to the optimum FOFW, a slipstream from the portion of fine tailings directed to the one or more thickeners is directed to the coarse sand tailings.

When the FOFW in the spiked coarse sand tailings reaches an optimum FOFW, being about 0.12, the MFT consumed from the substantially fixed volume tailings pond by the centrifuging is increased.

In another broad aspect, a system for managing oil sand tailings from a substantially continuously operating oil sands operation having an extraction process producing coarse sand tailings as an underflow from at least one cyclone and thickened tailings as an underflow from at least one thickener and a froth treatment process producing froth treatment tailings, each of, the coarse sand tailings, the thickened tailings and the froth treatment tailings having variable concentrations of fines therein, the system comprising: a tailings pond having a substantially fixed volume sufficient for storing at least the froth treatment tailings therein and for forming at least mature fine tailings (MFT) therefrom; a coarse sand beach for storing at least the coarse sand tailings; one or more centrifuges for centrifuging at least a portion of the MFT from the substantially fixed volume tailings pond for producing a centrifuge cake for deposit; and a thickened tailings beach for receiving the thickened tailings from the at least one thickener, the thickened tailings beach producing, over time, non-segregating tailings having sufficient strength to be trafficable; wherein the coarse sand tailings is spiked with fines for maintaining a fines-to-fines-plus-water ratio (FOFW) from about 0.10 to about 0.14 at the coarse sand beach, for producing, over time, consolidated tailings having sufficient strength to be trafficable; and wherein the fines for spiking the coarse sand tailings stream are one or more of MFT removed from substantially fixed volume tailings pond and a thickener feed stream.

### DETAILED DESCRIPTION OF THE PREFERRED EMBODIMENTS

Embodiments of the invention utilize tailings pond management techniques in an oil sands operation to minimize fluid fine tailings accumulations and to treat the fluid fine tailings produced during operation, from start-up through to end-of-life. As a result, a relatively small fixed containment volume is required. The fixed volume is minimized and maintained largely due to a managed balancing of production and consumption of mature fine tailings (MFT) therein resulting in a substantially steady-state volume of MFT.

In embodiments of the invention, the fixed containment volume typically comprises a single tailings pond 1 at any given time during the operation however the location of the single tailings pond 1 may change, such as moving the tailings pond 1 from external to the surface mining operation to in-pit when sufficient in-pit space is available.

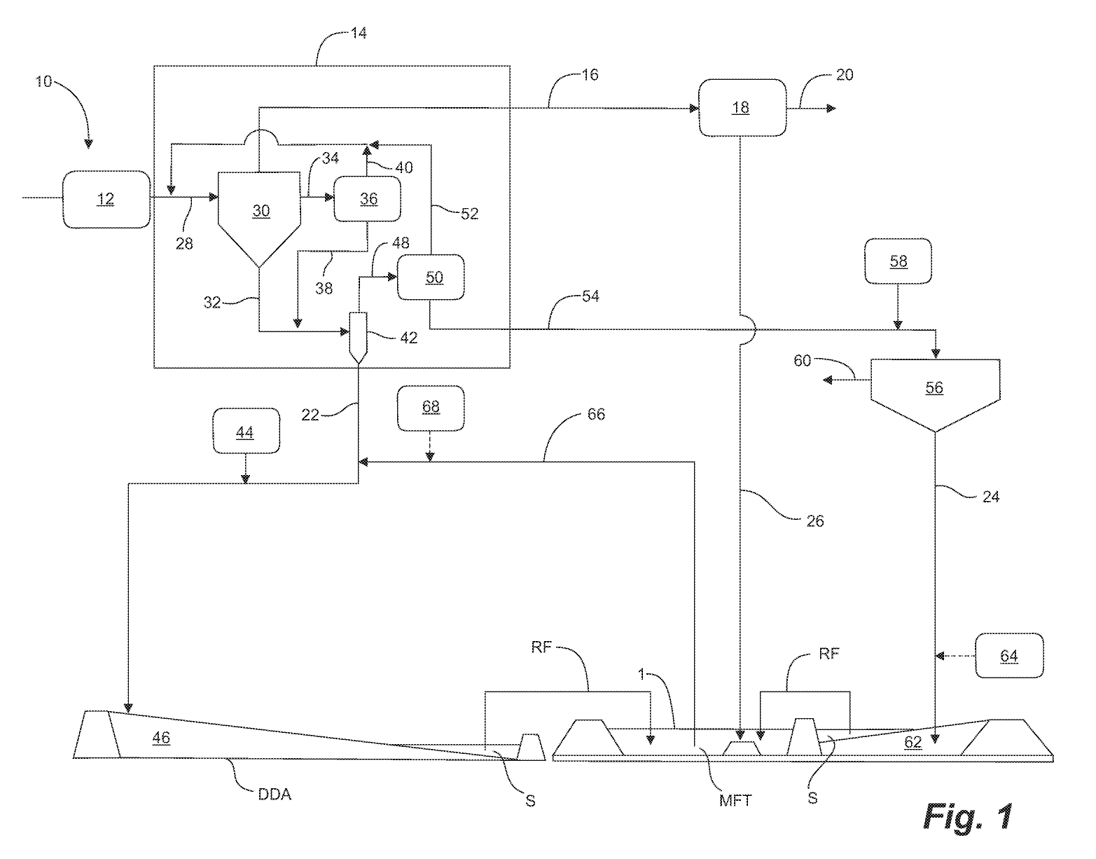

Embodiments of the invention are practiced with a conventional warm water extraction process. Having reference to FIG. 1, the operation utilizes conventional technology in at least an ore handling and slurry preparation plant 10 for producing a slurry 12, an extraction plant 14 for removing a bitumen-rich froth stream 16 from the slurry 12 and a froth treatment plant 18 for producing a bitumen product 20.

Three primary tailings streams are ultimately produced according to the process as described herein, the three tailings streams being by-products for disposal. The three primary tailings streams comprise coarse sand tailings 22 and thickened tailings 24, arising from the extraction plant 14, and froth treatment tailings 26, which arises from the froth treatment plant 18.

The three primary tailings streams 22, 24, 26 are produced, handled and managed according to embodiments of the invention, as described below.

### Production and Handling of Primary Tailings Streams

As shown in FIG. 1, and in an embodiment of the invention, mined oil sand is crushed and mixed with warm water for forming the slurry 12, the slurry 12 being transported by a hydrotransport pipeline 28 to the extraction plant 14. In the extraction plant 14, the slurry 12 is first gravity-separated in a primary separation cell 30 to produce a tailings underflow stream 32 and the bitumen-rich froth overflow stream 16 which is directed to the froth treatment plant 18.

A middlings stream 34 is removed from the primary separation cell 30 and is directed to a primary flotation cell 36 for producing a fines-rich primary flotation underflow stream 38 and a bitumen-rich, primary flotation froth overflow stream 40 comprising primarily residual bitumen and water. The primary flotation overflow stream 40 is recycled back to the primary separation cell 30 with the slurry feed 12. The fines-rich, primary flotation underflow stream 38 is combined with the primary separation cell tailings underflow stream 32 and is directed to one or more hydrocyclones or cyclones 42.

The bitumen-rich froth overflow stream 16 is directed to the froth treatment plant 18 for further processing as is known in the art. The bitumen-rich froth overflow stream 16 is generally treated using conventional solvent-based froth treatment processes to produce an undiluted froth product, being the bitumen product 20 and the froth treatment tailings stream 26. The bitumen product 20 is generally transported for export by pipeline to one or more offsite upgraders for further product refining.

### Coarse Sand Tailings

The one or more cyclones 42 in the extraction plant 14 produce a densified cyclone underflow stream which is the coarse sand tailings 22. The coarse sand tailings 22 are transported therefrom for disposal. The coarse sand tailings 22 typically consist of relatively coarse particles of solid sands, typically greater than 44 μm in diameter, with a small amount of water, fines and bitumen. Dilution water 44 is added as required to enable pumping, such as centrifugal pumping, of the coarse sand tailings 22 to a dedicated disposal area for forming a coarse sand beach 46. The coarse sand tailings stream 22 is largely segregating, depending upon the ratio of sand/fines present in the cyclone underflow 22.

### Thickened Fine Tailings

The one or more cyclones 42 also produce a fines-rich cyclone overflow 48 which is directed to one or more secondary flotation cells 50 for further separation to produce a secondary flotation overflow 52, which is largely water and bitumen froth, and a fines-rich, secondary flotation underflow 54. The secondary flotation overflow 52 is typically recycled back to the slurry feed 12 at the primary separation cell 30.

The secondary flotation, fines-rich, underflow 54 is directed, as a fines-rich thickener feed stream 54, to one or more thickeners 56 for recovery of warm water and for de-watering of the fines therein. A flocculant 58, typically a polymer, is generally added to the fines-rich thickener feed 54 to aid in separation in the one or more thickeners 56, as is understood in the art. Each of the one or more thickeners 56 separates the fines-rich feed 54 into a thickener overflow 60 and a thickener underflow, which is a stream of thickened tailings 24. The thickener overflow 60 is substantially clean, warm water. Thereafter, the thickened tailings 24 are pumped for disposal to a thickened tailings dedicated disposal area where the thickened tailings 24, which are largely fines and water, form a thickened tailings beach 62. The thickened tailings 24 at the thickened tailings beach 62 are largely non-segregating.

### Froth Treatment Tailings

A by-product from the froth treatment processes in the froth treatment plant 18 is the froth treatment tailings 26 which typically comprise water, fine solids, precipitated asphaltenes and a very small amount of hydrocarbons and unrecovered solvent. The froth treatment tailings 26 are transported, typically by pipeline, to the tailings pond 1 for containment and production of MFT therein.

The overall volume of the tailings pond 1 is largely governed by the volume of the froth treatment tailings 26 produced at the froth treatment plant 18. As discussed below, the fixed volume of the tailings pond 1 is only as large as necessary to develop sufficient MFT for managed consumption.

### Management of Fine Tailings Streams

Having reference again to FIG. 1, in a substantially continuously-operating oil sands operation, a fine tailings management system comprises the single tailings pond 1. The tailings pond 1 has the small, fixed volume for collection and containment of residual fluid fine tailings which are not otherwise managed or consumed by the operation prior to deposition in the tailings pond 1. As previously noted, the location of the tailings pond 1 may change, such as from external to the mining operation to in-pit, however only a single tailings pond 1 is actively used at any one time. The system also manages residual water, such as from site runoff and thickener overflow 60, which is generally recycled for re-use in the oil sand operation.

Each of the coarse tailings 22, the thickened tailings 24 and the froth treatment tailings 26 has variable concentrations of fines therein, largely dependent upon the fines content of the mined ore and therefore, the amount of fines at any point in the operation is also variable. Increases or decreases in the amount of fines are considered in the overall management of the tailings streams 22,24,26 as will be discussed herein.

The system balances the froth treatment tailings 26 and the production of MFT in the tailings pond 1 with the consumption of MFT from the tailings pond 1 to maintain the MFT at the steady-state volume and as a result to maintain the tailings pond 1 at the fixed volume.

MFT are consumed from the tailings pond 1 in a number of processes, the respective volumes of MFT being directed to one or more of these processes being altered to maintain the substantially steady-state volume of MFT therein and to avoid the need for ever-increasing containment capacity or volume in the tailings pond 1.

Surprisingly, as a result of embodiments of the tailings management system described herein, the resulting fixed volume of the tailings pond 1 may be as small as about ⅕ the volume of conventional tailings ponds.

Additionally, fluids are released from pore spaces or voids in the coarse sand beach 46 and from the thickened tailings beach 62 as run-off fluid RF. The runoff fluid RF typically comprises water and fines which are not captured within the voids in the coarse sand beach 46 and the thickened tailings beach 62. The runoff fluids RF are directed to the tailings pond 1 for storage therein. The fines contained in the runoff fluids RF add to the accumulating MFT in the tailings pond 1.

In embodiments of the invention, return sumps S are provided at the coarse sand beach 46 and the thickened tailings beach 62 for collecting the runoff fluids RF. The volume of the return sumps S is minimized, being only as large as necessary to operate return dredge pump systems for directing the collected runoff fluids RF to the tailings pond 1.

### Thickened Fine Tailings

In embodiments of the invention, the fines-rich thickener feed 54 typically comprises sand and fine particles of solid material in a sand-to-fines ratio (SFR) of about 0.5 to about 1. The presence of sand at the desired ratio in the thickener feed 54 aids in the thickening process and helps to produce a reduced water content thickened tailings underflow 24 therefrom. Further, the organic flocculant 58 is added to achieve solid/liquid separation in the thickener 56. The thickener 56 promotes aggregation of flocculated solid particles therein, releasing the overflow of warm water 60 having low solids content, for recycling as required. The thickened tailings underflow 24 has a solids content of about 50% solids by weight, permitting pumping of the thickened tailings 24 to the thickened tailings beach 62. The thickened tailings 24 undergo shear thinning prior to being pumped and pipelined to the thickened tailings beach. The thickened tailings 24 are predominantly non-segregating which enables capture of a majority of fines within the thickened tailings beach 62.

The thickened tailings 24 at the thickened tailings beach 62 continue to densify and dewater therein to gain necessary strength for reclamation activities. Optionally, additional flocculant 64 may be added to the thickened tailings 24, if required, to enhance deposit characteristics.

Dewatering of the thickened tailings beach 62 allows for additional deposit strength gain. Dewatering is aided through exposure of the thickened tailings beach 62 to the environmental effects of drying and of freeze/thaw cycles, as is understood in the art.

Disposal of the fines-rich secondary flotation underflow 54 and ultimately, the thickened tailings 24, in designated disposal areas, such as the thickened tailings beach 62, rather than below water in the tailings pond 1, assists in reducing the volume of produced MFT and thus, aids in minimizing the containment volume which is required in the tailings pond 1

In an embodiment of the invention, the SFR in the fines-rich thickener feed 54 is maintained at about 0.8:1, typically by altering operating parameters of the one or more cyclones 42, such as by altering the back pressure. Where desired SFR is not obtained as a result of varying the cyclone operation, coarse sand is added directly to the thickener feed 54, from the cyclone underflow or coarse sand tailings 22, to achieve the desired SFR. In this way, preferential distribution of coarse sand tailings 22 may be given to the thickener feed 54 so as to achieve the desired geotechnical properties at the thickened tailings beach 62.

### Sand-Spiking

In embodiments of the invention, MFT are consumed from the tailings pond 1 by removing an MFT stream 66 from the tailings pond 1 and combining the MFT stream 66 with the coarse sand tailings 22 from the one or more cyclones 42, in a process which is called sand-spiking. The sand-spiking process results in a spiked, coarse sand tailings stream 22, which is transported to the dedicated disposal area DDA for forming the coarse sand beach 46. The MFT stream 66, which comprises primarily MFT and water, acts to add fines to the coarse sand tailings 22. Further, the water in the MFT aids in diluting the spiked coarse sand tailings 22 so that the spiked coarse sand stream 22 can be more readily transported by pumping and pipeline transport to the dedicated disposal area for sub-aerial disposal. The coarse sand tailings 22 settle quickly at the coarse sand tailings beach 46, trapping some of the fines and water in pore spaces therein. The remainder of the water and fines report to the return sump S as runoff fluids RF.

Applicant has discovered that there is an optimum FOFW within the coarse sand tailings beach 46. The optimum FOFW is in a range from about 0.10 to about 0.14 so as to form a deposit that consolidates quickly to form a trafficable deposit. If the amount of fines added to the coarse sand tailings stream 22 is too great, and the FOFW exceeds 0.14, the deposit properties of the coarse sand tailings beach 46 change from segregating to non-segregating. If the coarse sand tailings beach 46 becomes non-segregating, most of the fines are captured however the coarse sand tailings beach 46 forms a soft deposit which in the short term is not trafficable by heavy equipment and which has low geotechnical strengths. Thus, it was recognized that the management system according to embodiments of the invention could not rely on sand-spiking alone to handle the entirety of the MFT, particularly in the later years of mine operation.

Optionally, flocculant 68 may be added to the MFT stream 66 to ultimately enhance the geotechnical properties of the trafficable deposit produced by the coarse sand tailings beach 46.

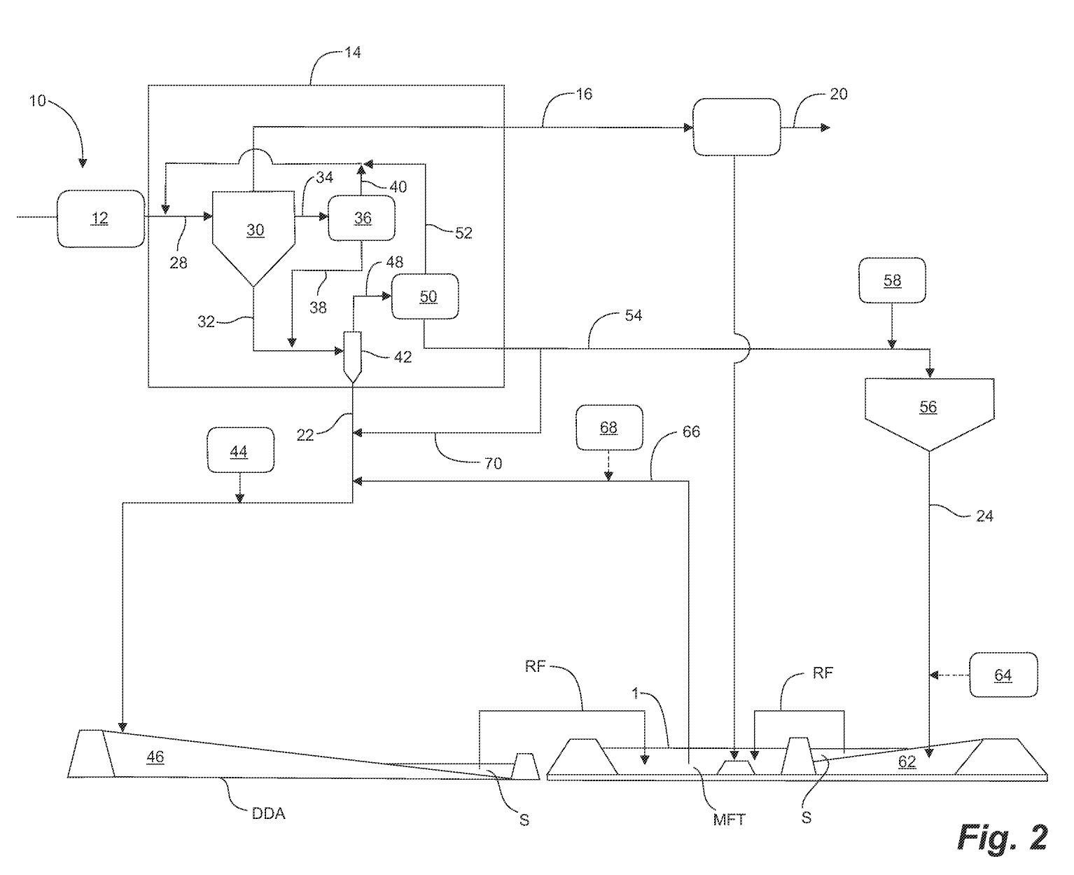

As shown in FIG. 2, at the beginning of operational life of the tailings pond 1, one of skill in the art would understand that there will not be sufficient MFT in the tailings pond 1 to provide sufficient fines for spiking the coarse sand tailings 22 to the optimum FOFW ratio to achieve the desired deposit characteristics at the coarse sand tailings beach 46. Accordingly, in early operations, at least a portion of the fines required to achieve the optimum FOFW ratio are provided by fines produced elsewhere in the operation, such as using at least a portion or slip stream 70 from the fines-rich thickener feed 54.

### Centrifugation Plant

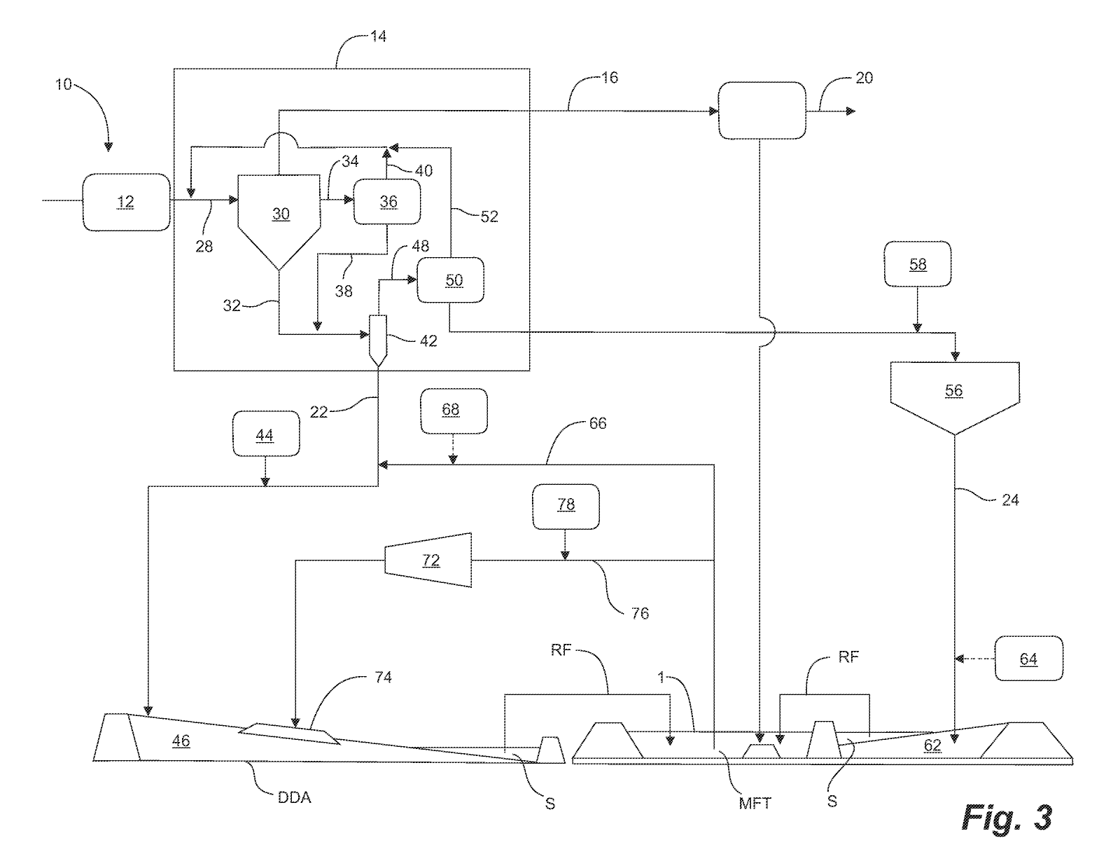

Having reference to FIG. 3, after several years of operation, more MFT are available in the tailings pond 1 than are required to achieve the optimum FOFW ratio at the coarse sand tailings beach 46. Further, at some time Applicant believes that the volume of MFT will increase so that the tailings pond 1 will reach or exceed the substantially fixed volume.

In embodiments of the invention, a centrifuge plant, such as one comprising one or more decanter-type centrifuges 72, is brought on-line in the tailings management system. The one or more centrifuges 72 consume residual volumes of MFT from the tailings pond 1 which cannot be consumed by spiking into the coarse sand tailings 22. As previously stated, if spiking of the coarse sand tailings 22 exceeds the optimum FOFW, the geotechnical characteristics of the coarse sand tailings beach 46 become undesirable.

When the volume of MFT in the tailings pond 1 reaches or exceeds that which can be maintained in the substantially fixed volume, excess MFT is transported from the tailings pond 1 to the one or more centrifuges 72 for centrifugal separation into a centrifuge cake 74 and a low-solids concentrate fluid stream (not shown). The low solids concentrate fluid stream is largely water.

MFT is pumped from the tailings pond 1 through a header to an MFT feed line 76 which feeds the one or more centrifuges 72. In an embodiment, an MFT supply barge pumps the MFT using pipelines connected to the header, The centrifuge cake 74 is trucked, conveyed or pumped, such as using positive displacement pumps, from the one or more centrifuges 72 for disposal at a dedicated disposal area. In embodiments of the invention, the centrifuge cake 74 is deposited at the coarse sand tailings beach 46, typically in polders thereon.

Optionally, organic polymers or flocculant 78 may be added to the MFT feed line 76 to increase the solids content of the centrifuge cake 74 and to enhance the quality and volume of water recovered therefrom. In embodiments of the invention, the centrifuge cake 74 has a solids content of from about 55% to about 60%.

Additional centrifuges 72 may be added to the centrifuge plant, as required.

Embodiments of the invention utilize the above-described processes to manage MFT inventories in the tailings pond 1 to a minimum volume during operation. The processes can be operated with different fines distributions therein to achieve the operational goals of minimizing MFT containment inventories and accordingly, minimizing the size of the tailings pond 1.

Table 1 illustrates some examples of different operational fines distributions and the resulting MFT inventory in tonnes per hour. Further, Table 1 illustrates the distribution of fines (<44 micron) in the mine feed systems in tonnes per operating hour (tph), the intermediate fines additions within the process and the resulting fines distributions within the final deposits and products.

TABLE 1

| | | EXAMPLE | | | |
|---|---|---|---|---|---|
| | | | 1B | | |
| | | 1A | Flotation | 1C | |
| | | Maximum | Addition, | Maximum | 1D |
| | | Spiking | Spiking | Flotation | Flotation |
| | | with | and | with | with |
| Stream No. | | Centrifuge | Centrifuge | Centrifuge | Centrifuge |
| (FIGS.) | Description/Units | (tph) | (tph) | (tph) | (tph) |

Incoming Fines to System

| | | | | | |
|---|---|---|---|---|---|
| 12 | Slurried Mine Feed | 1167.0 | 1167.0 | 1167.0 | 1167.0 |

Intermediate Fines Additions

| | | | | | |
|---|---|---|---|---|---|
| 70 | Flotation U/F Addition to Coarse U/F | 0.0 | 71.2 | 535.2 | 71.2 |
| 66 | MFT Addition to Coarse U/F Spiking | 433.5 | 314.9 | 0.0 | 0.0 |
| 76 | MFT to Centrifuge | 69.0 | 156.0 | 496.2 | 312.6 |

Fines Distribution

| | | | | | |
|---|---|---|---|---|---|
| 20 | Undiluted Product for Export | 4.2 | 4.2 | 4.2 | 4.2 |
| 26 | Froth Treatment Tailings Deposit | 57.1 | 57.1 | 57.1 | 57.1 |
| 46 | Coarse Sand Beach | 387.6 | 363.8 | 438.4 | 206.4 |
| 62 | Thickened Tailings Beach | 640.6 | 576.6 | 158.9 | 576.6 |
| 74 | Centrifuge Cake Deposit | 67.7 | 153.3 | 487.3 | 307.0 |

Residual Fine Tailings

| | | | | |
|---|---|---|---|---|
| MFT Inventory | 9.8 | 12.0 | 21.1 | 15.7 |

Example 1A illustrates fines distribution wherein spiking of the coarse sand tailings 22 with MFT is maximized so as to achieve the optimum FOFW at about 0.12 and a target of 50% solids content. As can be seen, the need to utilize the one or more centrifuges 72 to consume MFT from the tailings pond 1 for maintaining the steady-state volume of MFT is limited as a majority of the fines are captured in the coarse sand tailings beach 46 and the thickened tailings beach 62. Thus, Example 1A achieves the process goal of balancing MFT production and accumulation with MFT consumption for managing the MFT inventory in the tailings pond 1.

Example 1B is a variation of Example 1A wherein about 10% of the fines-rich, secondary flotation underflow stream 54 from the extraction plant 14 is spiked into the coarse sand tailings 22. The addition of fines from within the process advantageously lowers the tonnage of fines fed to the one or more in-plant thickeners 56 and also reduces the thickened tailings 24 deposited at the thickened tailings beach 62. The addition of flotation underflow 54 to the coarse sand tailings 22 limits the amount of MFT that can be consumed from the tailings pond 1 in order to maintain the optimum FOFW at about 0.12 and the target of 50% solids content. Redistribution of fines as described in Example 1B results in approximately twice the tonnage of MFT being directed to the one or more centrifuges 72 when compared to Example 1A. As can be seen however, the MFT inventory is maintained at approximately the same level.

In Example 1C, the addition of fines to the coarse sand tailings 22 from the secondary flotation underflow stream 54 is maximized to achieve the optimum FOFW of about 0.12 and the solids content of 50% in the coarse sand tailings 22. In this case, in order to maintain the MFT inventory at the steady-state volume, all of the MFT consumed from the tailings pond 1 is by the one or more centrifuges 72. As a result of the diversion of the thickener feed stream 54 to the coarse sand tailings 22, Example 1C results in the lowest tonnages of thickened tailings 24 deposited in the thickened tailings beach 62. As can be seen in this example, despite a variation in fines distribution through the various processes, the MFT volume in the tailings pond 1 is maintained at about the same level as Examples 1A and 1B.

Example 1D illustrates a variation of Example 1B. In this example, no MFT are consumed from the tailings pond 1 through spiking of the coarse sand tailings 22. As a result, there is a requirement to double the volume of MFT consumed from the tailings pond 1 by the one or more centrifuges 72 compared to Example 1B. Further, as a result, there is also a reduction in the fines captured in the coarse sand tailings beach 46. As can be seen in this example, despite a variation in fines distribution through the various processes, the MFT volume in the tailings pond 1 is maintained at about the same level as Examples 1A, 1B and 1C.

### Example 2

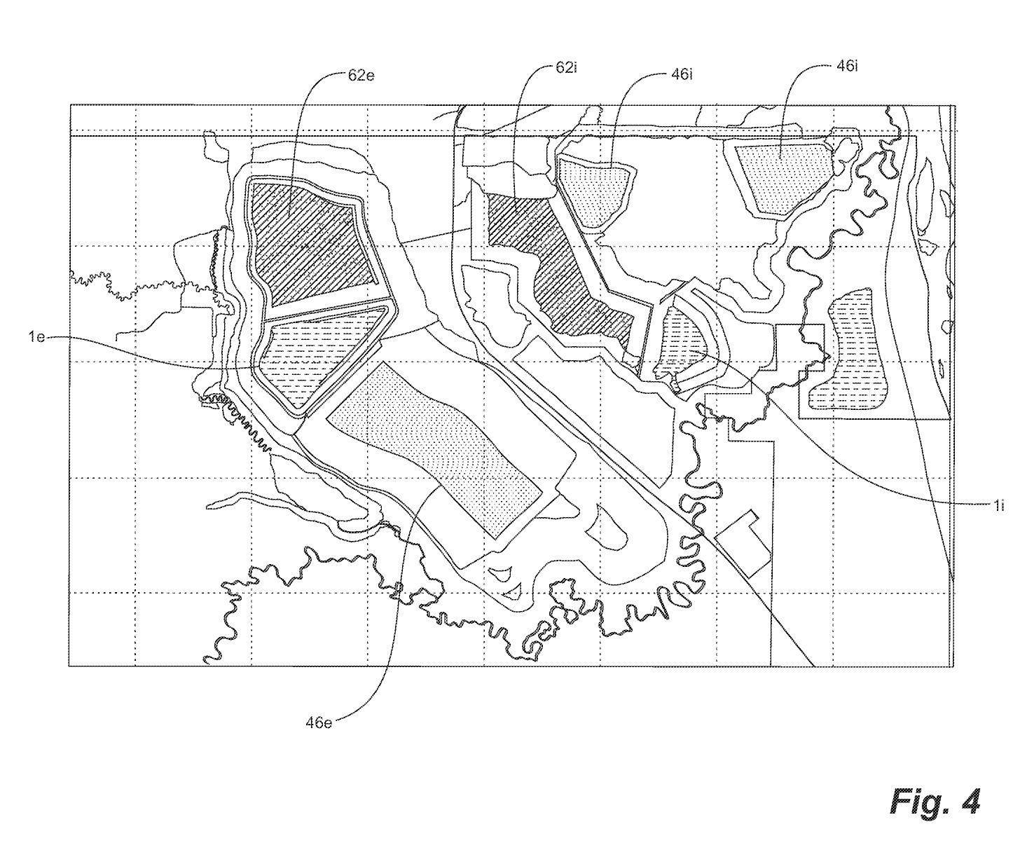

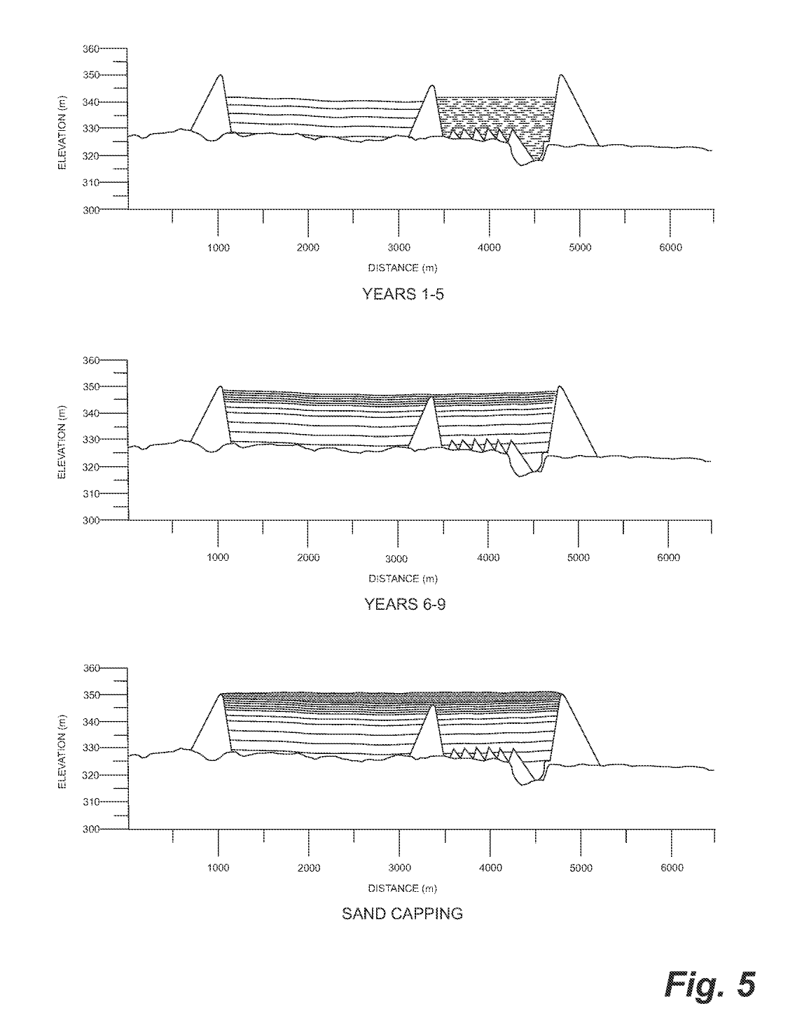

Having reference to FIGS. 4 and 5, an oil sand operation comprises a tailings management system according to an embodiment of the invention as described herein.

As can be seen in FIG. 4, the tailings pond 1 can be positioned advantageously between the coarse sand tailings beach 46 and the thickened tailings beach 62 due to its relatively small size. This is particularly the case at the beginning of operational life when the tailings pond 1, the coarse sand tailings beach 46 and the thickened tailings beach 62 are external to the mining operation. Later in operation life, the tailings pond 1, coarse sand tailings beach 46 and thickened tailings beach 62 can be moved in-pit and arranged according to available in-pit space. In embodiments of the invention, more than one coarse sand beach 46 or thickened tailings beach 62 can be used.

In an embodiment of the invention, the thickener feed stream 54 initially comprises about 20% solids. The thickened tailings 24 produced from the one or more thickeners 56 comprises about 50% solids. The thickened tailings beach 62 is expected to capture about 55% of the total mass of fines contained in the mined oil sands ore feed over the life of the operation. The thickened tailings 24 are deposited at a first external thickened tailings beach 62e for a number of years during which in-pit space is created. After sufficient in-pit space is available, the thickened tailings 24 are deposited at a second in-pit thickened tailings beach 62i for the remainder of the operational life.

The froth treatment tailings 26 are produced from start up of the froth treatment plant 18 and are deposited subaqueously in a first external tailings pond 1e. It is anticipated that MFT produced in the first tailings pond 1e will be largely consumed through sand-spiking for about 4 years after which there will be sufficient MFT inventory to bring the one or more centrifuges 72 on-line to receive a substantially continuous supply of MFT. The external tailings pond 1e will be used for about the same number of years as the external thickened tailings beach 62e, after which it will be retired and subsequently reclaimed. Thereafter, the froth treatment tailings 26 will be deposited subaqueously in a second in-pit tailings pond 1i.

The spiked, coarse sand tailings 22 will be used to construct perimeter containment for sand beaching using known hydraulic cell construction techniques. The coarse sand tailings beach 46 is expected to segregate to produce an 80% solids deposit. It is anticipated that the coarse sand tailings beach 46 will capture about 27% of the total mass of fines contained in the mined oil sands ore feed over the life of the operation. The coarse sand tailings 22 will be deposited at a first external coarse sand tailings beach 46e for about 6 years following retirement of the external thickened tailings beach 62e and the external tailings pond 1e. Thereafter, the coarse sand tailings 22 will be deposited in one or more in-pit disposal areas for forming one or more in-pit coarse sand tailings beaches 46i.

The accumulation of MFT in the tailings pond 1 is consumed by varying the consumption of MFT between sand-spiking and centrifugation wherein the volumes of MFT directed to each will be determined as the operation dictates, taking care not to exceed the stated range of FOFW ratio in the spiked coarse sand tailings 22 to maintain the geotechnical properties of the coarse sand tailings beaches 46e, 46i.

As shown in FIG. 5, when the thickened tailings beach 62 and the tailings pond 1 are retired, or reach the end of operational life, they are capped with sand to aid in final dewatering of the upper deposited layers in preparation for reclamation. Typically, sand capping will commence about 2 years after retirement or the end of the operation.

The following Tables 2 through 5 provide an example of the anticipated mass balances modeled for an operation producing tailings volumes according to Table 2 and managed according to an embodiment of the invention.

Table 2 is illustrative of anticipated annual tailings volumes modeled for an oil sand operation in the Athabasca Oil Sands of northern Alberta, Canada, managed according to an embodiment of the invention.

TABLE 2
PROJECTED ANNUAL TAILINGS VOLUMES

| | | | | | Centri- | Froth | Recycle |
|---|---|---|---|---|---|---|---|
| | Ore | Coarse | | | fuged | Treat- | Water |
| | Feed | Sand | Thickened | Fine | Fine | ment | Inven- |
| | Fines | Tailings | Tailings | Tailings | Tailings | Tailings | tory |
| Year | (%) | (Mm³) | (Mm³) | (Mm³) | (Mm³) | (Mm³) | (Mm³) |
| 1 | 18.8 | 1.4 | 0.7 | 0.3 | 0.0 | 0.1 | 11.0 |
| 2 | 15.6 | 21.4 | 9.9 | 4.1 | 0.0 | 1.7 | 11.0 |
| 3 | 15.8 | 27.7 | 11.7 | 6.2 | 0.0 | 2.1 | 11.0 |
| 4 | 16.2 | 28.1 | 10.7 | 3.0 | 0.00 | 2.1 | 11.0 |
| 5 | 15.6 | 28.4 | 10.2 | −1.4 | 1.3 | 2.1 | 11.0 |
| 6 | 16.2 | 28.2 | 10.3 | −0.7 | 1.2 | 2.1 | 11.0 |
| 7 | 16.7 | 27.9 | 10.3 | −0.2 | 1.2 | 2.2 | 11.0 |
| 8 | 16.9 | 28.0 | 10.3 | −0.1 | 1.2 | 2.1 | 11.0 |
| 9 | 16.5 | 28.1 | 10.1 | −0.6 | 1.2 | 2.1 | 11.0 |
| 10 | 18.4 | 27.6 | 10.8 | 1.2 | 1.2 | 2.2 | 11.0 |
| 11 | 17.9 | 27.6 | 10.4 | 0.6 | 1.1 | 2.2 | 11.0 |
| 12 | 18.5 | 27.3 | 10.5 | 1.0 | 1.2 | 2.2 | 11.0 |
| 13 | 19.6 | 27.1 | 10.9 | 2.0 | 1.2 | 2.2 | 11.0 |
| 14 | 16.7 | 28.1 | 9.8 | −0.8 | 1.1 | 2.1 | 11.0 |
| 15 | 14.5 | 28.8 | 9.2 | −2.6 | 1.2 | 2.1 | 11.0 |
| 16 | 15.6 | 28.4 | 9.6 | −1.3 | 1.2 | 2.1 | 11.0 |
| 17 | 15.5 | 28.5 | 9.6 | −1.3 | 1.2 | 2.1 | 11.0 |
| 18 | 17.9 | 27.7 | 10.4 | 0.9 | 1.2 | 2.2 | 11.0 |
| 19 | 16.7 | 28.0 | 9.8 | −0.4 | 1.1 | 2.1 | 11.0 |
| 20 | 15.8 | 28.3 | 9.5 | −1.3 | 1.1 | 2.1 | 11.0 |
| 21 | 15.8 | 28.4 | 9.6 | −1.2 | 1.2 | 2.1 | 11.0 |
| 22 | 14.9 | 12.7 | 2.3 | −3.4 | 1.2 | 0.9 | 11.0 |

| | | | | | | |
|---|---|---|---|---|---|---|
| Total | 567.6 | 206.7 | 4.0 | 21.0 | 43.4 | 11.0 |

Table 3 illustrates anticipated mass balance of solids and bitumen according to the operation shown in Table 2.

TABLE 3
ANTICIPATED MASS BALANCE OF SOLIDS AND BITUMEN

| | Mined Tonnage | | | Reject Tonnage | | | Tailings Deposit | | |
|---|---|---|---|---|---|---|---|---|---|
| | Coarse | Fines | | Coarse | Fines | | Coarse | Fines | |
| | (dry | (dry | Bitumen | (dry | (dry | Bitumen | (dry | (dry | Bitumen |
| Year | Mt) | Mt) | (dry Mt) | Mt) | Mt) | (dry Mt) | Mt) | Mt) | (dry Mt) |
| 1 | 2.3 | 0.5 | 0.3 | 0.1 | 0.0 | 0.0 | 2.3 | 0.5 | 0.1 |
| 2 | 36.6 | 8.0 | 5.6 | 1.5 | 0.3 | 0.1 | 35.0 | 7.6 | 1.0 |
| 3 | 48.3 | 9.1 | 7.3 | 2.0 | 0.4 | 0.1 | 46.3 | 8.7 | 1.3 |
| 4 | 48.2 | 9.3 | 7.2 | 2.0 | 0.4 | 0.1 | 46.2 | 8.9 | 1.3 |
| 5 | 48.5 | 9.0 | 7.2 | 2.0 | 0.4 | 0.1 | 46.5 | 8.6 | 1.3 |
| 6 | 48.2 | 9.3 | 7.2 | 2.0 | 0.4 | 0.1 | 46.2 | 8.9 | 1.3 |
| 7 | 47.8 | 9.6 | 7.3 | 2.0 | 0.4 | 0.1 | 45.8 | 9.1 | 1.3 |
| 8 | 47.8 | 9.7 | 7.2 | 2.0 | 0.4 | 0.1 | 45.8 | 9.3 | 1.3 |
| 9 | 48.1 | 9.5 | 7.1 | 2.0 | 0.4 | 0.1 | 46.1 | 9.0 | 1.3 |
| 10 | 47.3 | 10.6 | 6.9 | 2.0 | 0.5 | 0.1 | 45.2 | 10.2 | 1.2 |
| 11 | 47.4 | 10.3 | 7.1 | 2.0 | 0.4 | 0.1 | 45.3 | 9.8 | 1.2 |
| 12 | 46.8 | 10.6 | 7.3 | 2.0 | 0.5 | 0.1 | 44.9 | 10.1 | 1.3 |
| 13 | 46.6 | 11.4 | 6.9 | 2.0 | 0.5 | 0.1 | 44.5 | 10.8 | 1.2 |
| 14 | 48.0 | 9.6 | 7.0 | 2.0 | 0.4 | 0.1 | 46.0 | 9.2 | 1.2 |
| 15 | 49.3 | 8.4 | 7.1 | 2.1 | 0.4 | 0.1 | 47.2 | 8.0 | 1.3 |
| 16 | 48.6 | 9.0 | 7.1 | 2.0 | 0.4 | 0.1 | 46.6 | 8.6 | 1.2 |
| 17 | 48.8 | 9.0 | 7.0 | 2.1 | 0.4 | 0.1 | 46.8 | 8.5 | 1.2 |
| 18 | 47.5 | 10.3 | 6.9 | 2.0 | 0.4 | 0.1 | 45.5 | 9.9 | 1.2 |
| 19 | 47.9 | 9.6 | 7.1 | 2.0 | 0.4 | 0.1 | 46.0 | 9.2 | 1.3 |
| 20 | 48.4 | 9.1 | 7.2 | 2.0 | 0.4 | 0.1 | 46.4 | 8.7 | 1.3 |
| 21 | 48.6 | 9.1 | 6.9 | 2.0 | 0.4 | 0.1 | 46.6 | 8.7 | 1.2 |
| 22 | 21.7 | 3.8 | 3.2 | 0.9 | 0.2 | 0.1 | 20.8 | 3.6 | 0.6 |
| Total | 972.7 | 194.8 | 144.1 | 40.7 | 8.4 | 2.1 | 932.0 | 185.9 | 25.6 |

Table 4 illustrates anticipated mass balance of sand according to the operation shown in Table 2.

TABLE 4
ANTICIPATED SAND MASS BALANCE

| | Ore Feed | | | | | | | | |
|---|---|---|---|---|---|---|---|---|---|
| | (>44μ solids | | Sand in Slurry Streams | | | Sand in Deposits | | | |
| | fraction) | | (>44μ solids Fraction) | | | (>44μ solids Fraction) | | | |
| | Sand in | Rejects | SBA | Feed to | FTT | SBA | TT | CFT | FTT |
| | Ore Feed | (dry | Tailings | Thickener | Tailings | Deposit | Deposit | (dry | Deposit |
| Year | (dry Mt) | Mt) | (dry Mt) | (dry Mt) | (dry Mt) | (dry Mt) | (dry Mt) | Mt) | (dry Mt) |
| 1 | 2.3 | 0.1 | 2.0 | 0.2 | 0.0 | 2.0 | 0.2 | 0.0 | 0.0 |
| 2 | 36.6 | 1.5 | 31.2 | 3.5 | 0.4 | 31.3 | 3.4 | 0.0 | 0.4 |
| 3 | 48.3 | 2.0 | 41.2 | 4.6 | 0.5 | 41.3 | 4.5 | 0.0 | 0.5 |
| 4 | 48.2 | 2.0 | 41.1 | 4.6 | 0.5 | 41.2 | 4.5 | 0.0 | 0.5 |
| 5 | 48.5 | 2.0 | 41.4 | 4.6 | 0.5 | 41.3 | 4.6 | 0.1 | 0.5 |
| 6 | 48.2 | 2.0 | 41.1 | 4.6 | 0.5 | 41.1 | 4.5 | 0.1 | 0.5 |
| 7 | 47.8 | 2.0 | 40.8 | 4.5 | 0.5 | 40.7 | 4.5 | 0.1 | 0.5 |
| 8 | 47.8 | 2.0 | 40.8 | 4.5 | 0.5 | 40.7 | 4.5 | 0.1 | 0.5 |
| 9 | 48.1 | 2.0 | 41.0 | 4.6 | 0.5 | 41.0 | 4.5 | 0.1 | 0.5 |
| 10 | 47.3 | 2.0 | 40.3 | 4.5 | 0.5 | 40.3 | 4.4 | 0.1 | 0.5 |
| 11 | 47.4 | 2.0 | 40.4 | 4.5 | 0.5 | 40.4 | 4.4 | 0.1 | 0.5 |
| 12 | 46.8 | 2.0 | 39.9 | 4.4 | 0.5 | 39.8 | 4.4 | 0.1 | 0.5 |
| 13 | 46.6 | 2.0 | 39.7 | 4.4 | 0.5 | 39.6 | 4.4 | 0.1 | 0.5 |
| 14 | 48.0 | 2.0 | 41.0 | 4.5 | 0.5 | 40.9 | 4.5 | 0.1 | 0.5 |
| 15 | 49.3 | 2.1 | 42.0 | 4.7 | 0.5 | 42.0 | 4.6 | 0.1 | 0.5 |
| 16 | 48.6 | 2.0 | 41.5 | 4.6 | 0.5 | 41.4 | 4.6 | 0.1 | 0.5 |
| 17 | 48.8 | 2.1 | 41.6 | 4.6 | 0.5 | 41.5 | 4.6 | 0.1 | 0.5 |
| 18 | 47.5 | 2.0 | 40.5 | 4.5 | 0.5 | 40.4 | 4.5 | 0.1 | 0.5 |
| 19 | 47.9 | 2.0 | 40.9 | 4.5 | 0.5 | 40.8 | 4.5 | 0.1 | 0.5 |
| 20 | 48.4 | 2.0 | 41.3 | 4.6 | 0.5 | 41.2 | 4.6 | 0.1 | 0.5 |
| 21 | 48.6 | 2.0 | 41.5 | 4.6 | 0.5 | 41.4 | 4.6 | 0.1 | 0.5 |
| 22 | 21.7 | 0.9 | 18.5 | 2.1 | 0.2 | 18.5 | 2.0 | 0.1 | 0.2 |
| Total | 972.7 | 40.7 | 829.7 | 92.2 | 10.1 | 828.8 | 91.3 | 1.8 | 10.1 |

Table 5 illustrates anticipated mass balance of fines according to the operation shown in Table 2.

TABLE 5
ANTICIPATED FINES MASS BALANCE

| | Ore Feed | | | | | |
|---|---|---|---|---|---|---|
| | (>44μ solids | | Fines in Deposits | | | |
| | Fraction) | | (>44μ solids Fraction) | | | |
| | Fines in | Rejects | SBA | TT | CFT | FTT |
| | Feed | Fines | Deposit | Deposit | (dry | Deposit |
| Year | (dry Mt) | (dry Mt) | (dry Mt) | (dry Mt) | Mt) | (dry Mt) |
| 1 | 0.5 | 0.0 | 0.1 | 0.3 | 0.0 | 0.0 |
| 2 | 8.0 | 0.3 | 1.9 | 4.2 | 0.0 | 0.4 |
| 3 | 9.1 | 0.4 | 1.7 | 4.8 | 0.0 | 0.4 |
| 4 | 9.3 | 0.4 | 2.5 | 4.9 | 0.0 | 0.4 |
| 5 | 9.0 | 0.4 | 2.5 | 4.7 | 1.2 | 0.4 |
| 6 | 9.3 | 0.4 | 2.5 | 4.9 | 1.2 | 0.4 |
| 7 | 9.6 | 0.4 | 2.5 | 5.0 | 1.2 | 0.4 |
| 8 | 9.7 | 0.4 | 2.5 | 5.1 | 1.2 | 0.5 |
| 9 | 9.5 | 0.4 | 2.5 | 5.0 | 1.2 | 0.4 |
| 10 | 10.6 | 0.5 | 2.5 | 5.6 | 1.2 | 0.5 |
| 11 | 10.3 | 0.4 | 2.5 | 5.4 | 1.2 | 0.5 |
| 12 | 10.6 | 0.5 | 2.5 | 5.6 | 1.2 | 0.5 |
| 13 | 11.4 | 0.5 | 2.4 | 6.0 | 1.3 | 0.5 |
| 14 | 9.6 | 0.4 | 2.5 | 5.1 | 1.3 | 0.5 |
| 15 | 8.4 | 0.4 | 2.6 | 4.4 | 1.3 | 0.4 |
| 16 | 9.0 | 0.4 | 2.5 | 4.7 | 1.4 | 0.4 |
| 17 | 9.0 | 0.4 | 2.6 | 4.7 | 1.3 | 0.4 |
| 18 | 10.3 | 0.4 | 2.5 | 5.4 | 1.3 | 0.5 |
| 19 | 9.6 | 0.4 | 2.5 | 5.1 | 1.3 | 0.5 |
| 20 | 9.1 | 0.4 | 2.5 | 4.8 | 1.3 | 0.4 |
| 21 | 9.1 | 0.4 | 2.6 | 4.8 | 1.3 | 0.4 |
| 22 | 3.8 | 0.2 | 1.1 | 2.0 | 1.3 | 0.2 |
| 23 | 0.0 | 0.0 | 0.0 | 0.0 | 2.2 | 0.0 |
| Total | 194.8 | 8.4 | 50.0 | 102.5 | 24.9 | 9.0 |

The embodiments of the invention in which an excusive property or privileged is claimed are defined as follows:

1. A method for managing fine tailings in a continuously operating oil sands operation producing, as by-products, at least fine tailings and coarse sand tailings therefrom, the method comprising:
directing a portion of the fine tailings to one or more thickeners for producing thickened tailings therefrom, the thickened tailings being substantially non-segregating;
directing a portion of the fine tailings to a substantially fixed volume tailings pond, the substantially fixed volume being sufficient for containing the portion of fine tailings therein and for forming at least mature fine tailings (MFT) therefrom; and
consuming the MFT from the substantially fixed volume tailings pond for maintaining a substantially steady-state volume of MFT therein and the substantially fixed volume of the tailings pond,
wherein the consuming of the MFT is by one or more of
spiking the coarse sand tailings with the MFT for forming spiked coarse sand tailings having an optimum fines-over-fines-plus ratio (FOFW) from about 0.10 to about 0.14 for forming segregating tailings; and
centrifuging the MFT for forming a centrifuge cake for disposal.

2. The method of claim 1 wherein the optimum FOFW is about 0.12.

3. The method of claim 1 wherein when the volume of MFT in the substantially fixed volume tailings pond is insufficient to spike the coarse sand tailings to the optimum FOFW, the method further comprising:
directing a slipstream from the portion of fine tailings directed to the one or more thickeners to the coarse sand tailings.

4. The method of claim 1 wherein when the FOFW in the spiked coarse sand tailings reaches the optimum FOFW, the method further comprising
increasing the MFT consumed from the substantially fixed volume tailings pond by the centrifuging.

5. The method of claim 1 wherein the directing a portion of the fine tailings to the one or more thickeners comprises
directing a fines-rich underflow stream from secondary flotation in an extraction plant to the one or more thickeners.

6. The method of claim 1 wherein the directing a portion of the fine tailings to the substantially fixed volume tailings pond comprises:
directing froth treatment tailings from a froth treatment plant to the substantially fixed volume tailings pond.

7. The method of claim 1 wherein the portion of fines directed to the one or more thickeners is an underflow from one or more cyclones, the method further comprising:
altering operating parameters of the one or more cyclones for providing a sand-to-fines ratio (SFR) in a range from about 0.5 to about 1.0 in the portion of fines.

8. The method of claim 7 wherein SFR is in a range from about 0.8 to about 1.0.

9. The method of claim 1 wherein the producing non-segregating thickened fine tailings from the thickener further comprises:
adding flocculent to the portion of fine tailings directed to the one or more thickeners.

10. The method of claim 1 further comprising:
adding flocculent to the thickened tailings from the one or more thickeners.

11. The method of claim 1 further comprising:
depositing the thickened tailings in a dedicated disposal area, forming a thickened tailings beach for producing a trafficable deposit therefrom.

12. The method of claim 11 further comprising:
collecting run-off fluid and fine tailings from the thickened tailings beach; and
directing the run-off fluid and fine tailings to the substantially fixed volume tailings pond for forming MFT therein.

13. The method of claim 1 further comprising:
depositing the spiked coarse sand tailings at a dedicated disposal area, forming a coarse sand beach for producing a trafficable deposit therefrom.

14. The method of claim 13 further comprising:
collecting run-off fluid and fine tailings from the coarse sand tailings beach; and
directing the run-off fluid and fine tailings to the substantially fixed volume tailings pond for forming MFT therein.

15. The method of claim 13 further comprising
depositing the centrifuge cake at the coarse sand beach for the disposal.

16. A system for managing oil sand tailings from a substantially continuously operating oil sands operation having an extraction process producing coarse sand tailings as an underflow from at least one cyclone and thickened tailings as an underflow from at least one thickener and a froth treatment process producing froth treatment tailings, each of, the coarse sand tailings, the thickened tailings and the froth treatment tailings having variable concentrations of fines therein, the system comprising:
a tailings pond having a substantially fixed volume sufficient for storing at least the froth treatment tailings therein and for forming at least mature fine tailings (MFT) therefrom;
a coarse sand beach for storing at least the coarse sand tailings;
one or more centrifuges for centrifuging at least a portion of the MFT from the substantially fixed volume tailings pond for producing a centrifuge cake for deposit; and
a thickened tailings beach for receiving the thickened tailings from the at least one thickener, the thickened tailings beach producing, over time,
non-segregating tailings having sufficient strength to be trafficable;
wherein the coarse sand tailings is spiked with fines for maintaining a fines-to-fines-plus-water ratio (FOFW) from about 0.10 to about 0.14 at the coarse sand beach, for producing, over time,
consolidated tailings having sufficient strength to be trafficable; and
wherein the fines for spiking the coarse sand tailings stream are one or more of MFT removed from substantially fixed volume tailings pond and a thickener feed stream.

17. The system of claim 16 wherein an optimum FOFW is about 0.12.

18. The system of claim 16 wherein the coarse sand tailings beach further produces, over time
fluid comprising at least water and a portion of fines from the coarse sand beach, the fluid being directed to the substantially fixed volume tailings pond for producing MFT therein.

19. The system of claim 16 wherein the thickened tailings beach further produces, over time
fluid comprising at least water and a portion of fines from the thickened tailings beach, the fluid being are directed to the substantially fixed volume tailings pond for producing MFT therein.

20. The system of claim 16 wherein a feed stream to the at least one thickener has a sand-to-fines ratio in a range from about 0.5 to about 1.0.

21. The system of claim 16 wherein a feed stream to the at least one thickener has a sand-to-fines ratio in a range from about 0.8 to about 1.0.

22. The system of claim 18 wherein the fluid produced by the coarse sand beach is collected at the coarse sand beach and removed therefrom to the substantially fixed volume tailings pond by a dredge pump.

23. The system of claim 19 wherein the fluid produced by the thickened tailings beach is collected at the thickened tailings beach and is removed therefrom to the substantially fixed volume tailings pond by a dredge pump.

24. The system of claim 16 wherein the substantially fixed volume tailings pond is positioned between the coarse sand tailings beach and the thickened tailings beach.
